(19) United States
(12) Patent Application Publication
(10) Pub. No.: US 2026/0176092 A1
(43) Pub. Date: Jun. 25, 2026

(54) SAFETY DEVICE, IMPROVED LEVELERS, IMPROVED LOADING DOCKS

(71) Applicant: GMA Loading Dock Equipment, Concord, NC (US)

(72) Inventor: Gary Michael GREENE, Charlotte, NC (US)

(21) Appl. No.: 19/428,939

(22) Filed: Dec. 22, 2025

Related U.S. Application Data
(60) Provisional application No. 63/737,155, filed on Dec. 20, 2024.

(51) Int. Cl. B65G 69/28

(52) U.S. Cl. CPC B65G 69/2876

(57) ABSTRACT

A safety device includes a mounting plate for attachment to host structure, and a flap pivotally attached to the mounting plate defining a safety device pivot axis. The flap may be a rectangular polymer mat with reinforcing fiber. The flap may include fiber layers sandwiched between at least external sealing polymer layers. A proximal edge of the flap may be pivotally attached to a proximal edge of the mounting plate. An improved loading dock includes the safety device installed by way of the mounting plate being connected to a structure of the loading dock. The dock may have a ramp that pivots on a horizontal axis, the safety device pivot axis being perpendicular to the horizontal axis of the ramp.

### CROSS-REFERENCE TO RELATED APPLICATION

This application claims the benefit of priority of U.S. provisional patent application No. 63/737,155, titled “Safety Device, Improved Levelers, Improved Loading Docks” filed on Dec. 20, 2024, which is incorporated herein in its entirety by this reference.

### TECHNICAL FIELD

The present disclosure relates to safety equipment and measures for vehicle loading and unloading. More particularly, the present disclosure relates to a safety device and levelers and loading docks improved thereby.

### BACKGROUND

A typical loading dock at a facility where inventor and cargo are loaded and unloaded from vehicles such as large trucks typically have gaps between a floor and loading structures, even as loading occurs and workers pass over the gaps or nearby.

Whether levelers are installed or loading elevators are in place, the variety of floor heights, door architectures, and trucks that are all parts of our distribution system for goods and foods ultimately permit at least slight mismatches among surfaces at loading docks.

While some companies may have some degree of standardization among their facilities, the trucks that serve them are likely to vary in industries where cost efficiencies and timing must overrule any expectation that all docks and all trucks meet tight standards. Some tolerance is needed at least for human drivers, who at times drive for hours and are expected to expertly dock a truck by reverse movement. Thus loading structures and equipment are unlikely to always or even ever have truly closed out connections and floors.

### SUMMARY

This summary is provided to briefly introduce concepts that are further described in the following detailed descriptions. This summary is not intended to identify key features or essential features of the claimed subject matter, nor is it to be construed as limiting the scope of the claimed subject matter.

In at least one embodiment, a safety device includes a mounting plate, and a flap pivotally attached to the mounting plate defining a safety device pivot axis.

The flap may be implements as a rectangular polymer mat with reinforcing fiber.

The flap may include fiber layers sandwiched between at least external sealing polymer layers.

A proximal edge of the flap may be pivotally attached to a proximal edge of the mounting plate.

An improved loading dock includes the safety device installed by way of the mounting plate being connected to a structure of the loading dock. The dock may have a ramp that pivots on a horizontal axis, the safety device pivot axis being perpendicular to the horizontal axis of the ramp.

In at least one embodiment a safety device for a loading dock includes: a flap for covering a gap at a loading dock; and a mounting plate pivotally attached to the flap. The mounting plate is configured to pivotally mount the flap to a portion of the loading dock. The flap is pivotable relative to the mounting plate at least to an orthogonal position relative the mounting plate corresponding to a raised position relative to the loading dock and to a parallel position relative to the mounting plate corresponding to a deployed position relative to the loading dock and covering the gap.

The mounting plate may be pivotally attached to the flap by way of a proximal edge of the mounting plate being pivotally attached to a proximal edge of the flap along a pivot axis.

A hinge plate may be attached to the flap and immovable relative to the flap, and the hinge plate may be pivotally attached to the mounting plate at the pivot axis.

The hinge plate and mounting plate may define a hinge.

The hinge plate and mounting plate may be pivotally attached at proximal edges thereof by mutually interdigitated rolls receiving and trapping a hinge pin disposed along the pivot axis.

The flap may have a greater area than an area of the mounting plate.

The flap in the deployed position may extend over and beyond the mounting plate in two dimensions.

The flap and mounting plate may each be rectangular.

A length of the flap, as measured parallel to the pivot axis, may be greater than a length of the mounting plate.

The flap may be pivotally attached to and longitudinally centered on the mounting plate, such that two longitudinal ends of the flap in the deployed position respectively overhang two longitudinal ends of the mounting plate.

A width of the flap, as measured perpendicular to the length of the flap and perpendicular to the pivot axis, may be greater than a width of the mounting plate.

The flap and mounting plate may be pivotally attached at the proximal edges thereof such that, such that the flap in the deployed position covers the mounting plate.

The above summary is to be understood as cumulative and inclusive. The above and below described features are to be understood as combined in whole or in part in various embodiments whether expressly described herein or implied by at least this reference. For brevity, not all features are expressly described and illustrated as combined with all other features. No combination of features shall be deemed unsupported for merely not appearing expressly in the drawings and descriptions.

### BRIEF DESCRIPTION OF THE DRAWINGS

The previous summary and the following detailed descriptions are to be read in view of the drawings, which illustrate some, but not all, embodiments and features as briefly described below. The summary and detailed descriptions, however, are not limited to only those embodiments and features explicitly illustrated.

FIG. 1 is a perspective view of a prior art loading dock with a leveler flanked by wall-mounted bumpers.

FIG. 2 is a perspective view of an improved loading dock with a leveler flanked by wall-mounted bumpers and inventive safety devices installed and in their deployed positions.

FIG. 3 is a plan view of an inventive safety device according to at least one embodiment.

FIG. 4 is a perspective view of the improved loading dock of FIG. 2, with the inventive safety devices in their raised positions and a door raised.

FIG. 5 is a perspective view of the improved loading dock of FIG. 4, with the inventive safety devices in their deployed positions.

FIG. 6 is a perspective view of the improved loading dock of FIG. 5, with the inventive safety devices in their deployed positions and a truck positioned to receive or deliver inventory across a deployed ramp of the truck with the inventive safety devices in use.

FIG. 7 is a perspective view of an inventive safety device in a raised position according to at least one embodiment.

FIG. 8 is an elevation view of the inventive safety device of FIG. 7 in a folded configuration according to at least one embodiment.

FIG. 9 is an elevation view of the inventive safety device of FIG. 8 to show the raised position from a side.

### DETAILED DESCRIPTIONS

These descriptions are presented with sufficient details to provide an understanding of one or more particular embodiments of broader inventive subject matters. These descriptions expound upon and exemplify particular features of those particular embodiments without limiting the inventive subject matters to the explicitly described embodiments and features. Considerations in view of these descriptions will likely give rise to additional and similar embodiments and features without departing from the scope of the inventive subject matters. Although steps may be expressly described or implied relating to features of processes or methods, no implication is made of any particular order or sequence among such expressed or implied steps unless an order or sequence is explicitly stated.

Any dimensions expressed or implied in the drawings and these descriptions are provided for exemplary purposes. Thus, not all embodiments within the scope of the drawings and these descriptions are made according to such exemplary dimensions. The drawings are not made necessarily to scale. Thus, not all embodiments within the scope of the drawings and these descriptions are made according to the apparent scale of the drawings with regard to relative dimensions in the drawings. However, for each drawing, at least one embodiment is made according to the apparent relative scale of the drawing.

Any materials described are provided as non-limiting examples except where their inclusion is positively and unambiguously asserted. Once materials and arrangements are described herein with reference to any structures and elements thereof, for example in the drawings, such descriptions apply as well to any further same or similar structures and elements that may appear in other drawings.

Like reference numbers used throughout the drawings depict like or similar elements. Unless described or implied as exclusive alternatives, features throughout the drawings and descriptions should be taken as cumulative, such that features expressly associated with some particular embodiments can be combined with other embodiments.

Unless defined otherwise, technical and scientific terms used herein have the same meaning as commonly understood to one of ordinary skill in the art to which the presently disclosed subject matter pertains.

Inventive products and methods for production thereof need not literally ever be implemented as expressly illustrated in the drawings, in which rectangular, linear, and/or other simple geometric graphical representations are shown. The drawings are to be taken as conceptual, representative, exemplary, and non-limiting. Each drawing nonetheless does literally represent at least an embodiment of its illustrated subject matter.

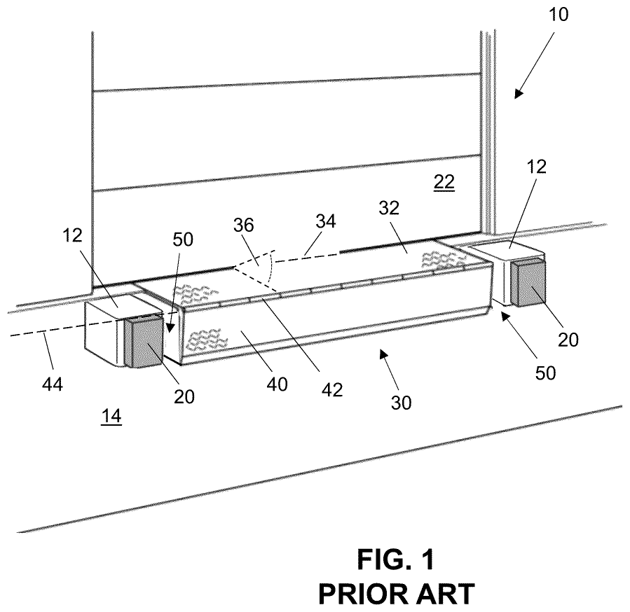

FIG. 1 is a perspective view of a prior art loading dock 10 with a leveler 30.

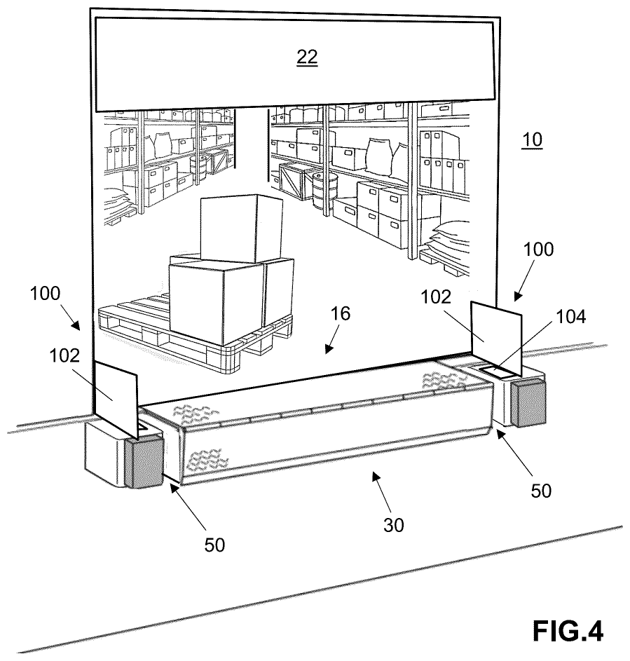

Abutments 12, which are typically bumpers supplied with a leveler and comprised of steel blocks with rubber front sides, extend from an outer wall 14 of the dock structure below or near the level of the floor 16 (FIG. 4), each aside a respective end of the leveler. A respective bumper 20 is mounted on each abutment 12 to reduce shock if struck by a vehicle approaching the dock. An exemplary roll-up or rail mounted door 22 is shown as closed (FIGS. 1-2) and open (FIGS. 4-6).

A typical dock leveler 30 has an adjustable ramp 32 at the edge of a loading dock to provide a smooth transition between the loading dock floor 16 to the floor or lift of a truck, trailer, or railcar, for loading and unloading. It can serve as a bridge, but also allows for variation in the height of two surfaces as the vehicle's suspension shifts during loading and unloading, and for variations among types of vehicles. The ramp 32 typically pivots at its rearward edge around a horizontal axis 34 to an adjustable slope angle 36 to accommodate said variation in height. The slope angle 36 in FIG. 1 may be exaggerated for illustration purposes. A forward lip 40 typically hinges from a forward edge 42 of the ramp 32, also pivoting around a horizontal axis 44, which is typically parallel to the axis 34. A typical ramp 32 is embodied as a rectangular steel plate with a traction-textured top surface hinged at or near its front and back edges.

As shown in FIG. 1, a respective gap 50 is typically present between each end of the leveler ramp 32 and a respective abutment 12 or other structure depending on the construction of a loading dock. This represents a potential safety issue and may permit loss of dropped items during loading and unloading operations without closing out or covering the gaps.

FIG. 2 is a perspective view of an improved loading dock, in which inventive safety devices 100 are installed and are shown in their deployed positions. Each safety device includes a flap 102, which in FIG. 2 covers a respective gap from above.

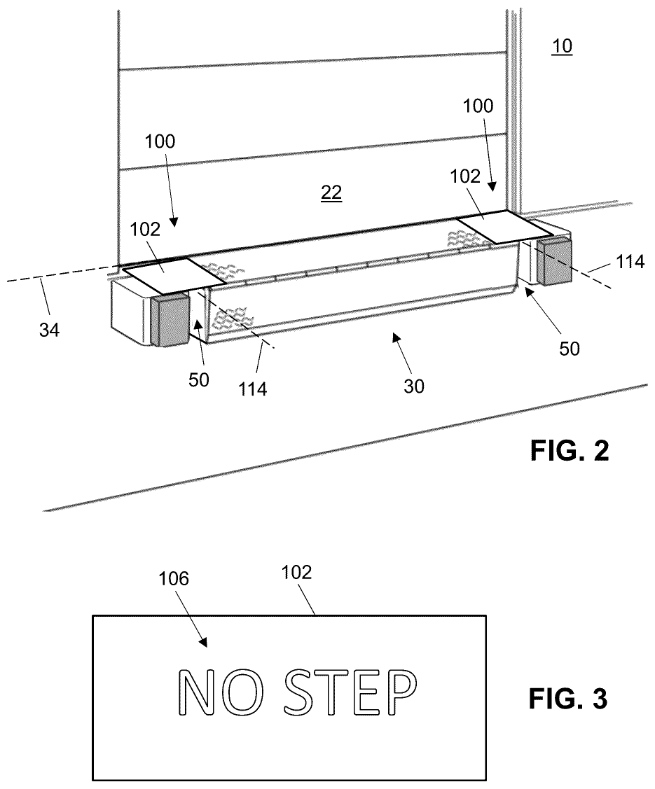

FIG. 3 shows the top side of the flap in plan view according to at least one embodiment. Indicia 106 shown as letters spelling the term “NO STEP” are expressly illustrated in FIG. 3 as a non-limiting example. Other indicia having any information and/or graphical appearance preferred are within the scope of these instructions. The optional indicia 106 may be inset lettering or graphics. The optional indicia 106 may be painted, inked, printed, or otherwise colorized and/or applied.

FIG. 4 is a perspective view of the improved loading dock of FIG. 2, with the inventive safety devices in their raised positions and the door raised to an open position. According to various door embodiments, the flaps 102 in their lowered or deployed positions may better accommodate the closing of the door 22 (FIG. 2) as when the dock is not in use.

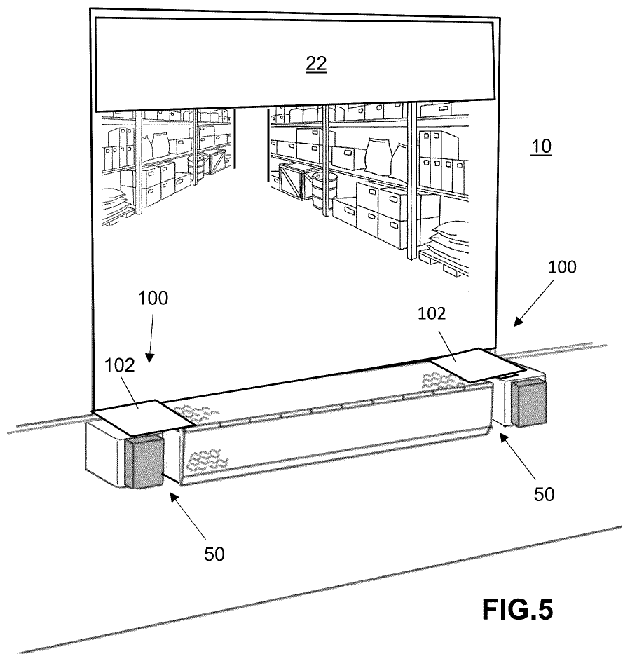

FIG. 5 shows the improved loading dock and door as in FIG. 4, with the inventive safety devices 100 in their deployed configurations each covering a respective gap 50.

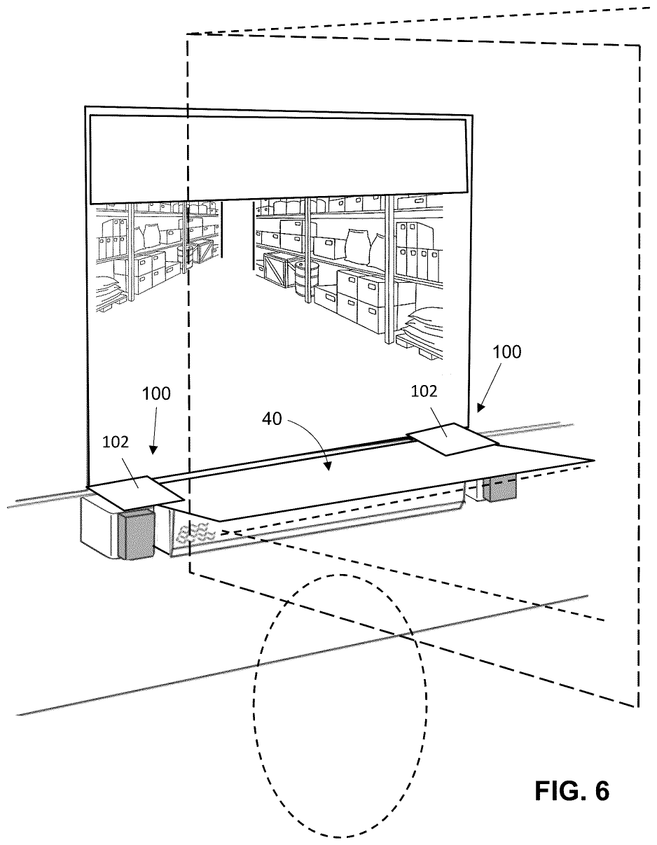

FIG. 6 is a perspective view of the improved loading dock of FIG. 5, with the inventive safety devices in their deployed positions and a truck shown in dashed line and positioned to receive or deliver inventory across a deployed ramp 40 of the truck with the inventive safety devices 100 in use. In some uses, as illustrated, the on-board ramp 40 of a vehicle may be used in lieu of or in cooperation with the leveler 30. In the illustrated use, the flaps 102 are deployed over the vehicle on-board ramp.

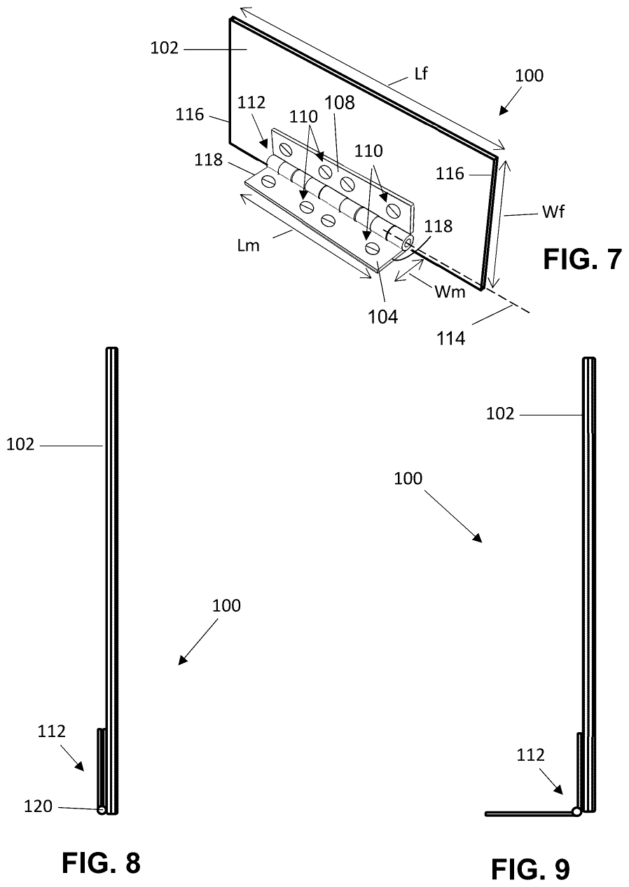

FIG. 7 is a perspective view of an inventive safety device 100, dismounted from a host structure and in a raised position according to at least one embodiment. The flap 102 is implemented in a non-limiting example as a rectangular panel of fiber reinforced polymer mat material, having interior textile or fiber layers sandwiched between at least external sealing polymer layers. The flap 102 in some embodiments is flexible to permit its deformation to accommodate ramps, levelers, and any floor or other structures for which the safety device is used to close out or cover gaps. Such flexibility and deformation also permit tolerance and variation among the surfaces of the working environment of the flap, with the flap conforming to prevent damage to other structures.

The flap 102 is pivotally attached at an edge thereof to a hinge 112 having an upper hinge plate 108 attached to the flap 102 and a mounting plate 104 pivotally attached to the upper hinge plate 108. The hinge plate 108 is immovable relative to the flap 102 and travels therewith relative to the mounting plate when the hinge pivots.

The upper hinge plate 108 and the mounting plate 104 have mounting holes 110 receiving fasteners such as bolts, screws, or rivets, as non-limiting examples. In the illustrated example (FIG. 7), bolt or screw heads with slots are shown in the mounting holes 110. The safety device 100 can be mounted to a host surface accordingly by way of mounting plate 104. The upper hinge plate 108 and mounting plate 104, in various embodiments, are constructed from a metal such as steel or aluminum. The pivotal attachment of the flap 102 and mounting plate 104 define a safety device pivot axis 114. In the illustrated embodiment, the flap 102 and mounting plate 104 are attached at their mutually proximal edges by mutually interdigitated rolls receiving and trapping a hinge pin 120 (FIG. 8), thus defining a durable hinge 112.

FIG. 8 is an elevation view of the inventive safety device 100 of FIG. 7 in a folded configuration, with the flap 102 and mounting plate 104 at least approximately parallel corresponding to the lowered or deployed position in FIGS. 2 and 5. FIG. 9 is an elevation view of the inventive safety device 100 of FIG. 7 in an unfolded configuration, with the flap 102 and mounting plate 104 at least approximately orthogonal. This corresponds to the raised or un-deployed configuration or position.

The flap 102 has a greater effective footprint than the mounting plate 204 to cover the mounting plate and at least partially close out a gap in use at a loading dock or other interrupted floor. The flap 102 has a greater area, defined in at least one example by a length Lf (FIG. 7) thereof multiplied by a width Wf thereof, than an area of the mounting plate 104, defined in at least one example by a length Lm (FIG. 7) thereof multiplied by a width Wm thereof. The flap 102 accordingly can extend over and beyond the mounting plate 104 in two dimensions in the deployed condition. Dimensions of the flap 102 and mounting plate 104 in the parallel configuration (FIG. 8), and their edgewise pivoting attachment, are such that the flap 102 when deployed reaches across a gap 50, such as that shown in FIGS. 2 and 5, beyond the mounting plate 104 and beyond a host structure (shown as abutment 12) to which the mounting plate 104 is connected to thereby bridge a nearby gap.

In the particularly illustrated example of FIG. 7, in which the flap 102 and mounting plate 104 are each rectangular, a length Lf of the flap 102, as measured parallel to the safety device pivot axis 114, is greater than a length Lm of the mounting plate 104. The flap 102 is attached longitudinally centered on the hinge 112 and mounting plate 104. Two longitudinal ends 116 of the flap 102 thus overhang two longitudinal ends 118 of the mounting plate 104 in the deployed condition to cover the mounting plate 104.

A width Wf of the flap 102, as measured perpendicular to the length Lf safety device pivot axis 114, is greater than a width Wm of the mounting plate 104, and the flap 102 and mounting plate 104 are attached at their edges mutually proximal the pivot axis. The flap 102 accordingly has maximal reach across a gap of a loading dock to close out the gap and to cover the mounting plate 104 in the deployed condition of the safety device 100 (FIG. 5).

In the illustrated environment and example of use, the safety device pivot axis 114 is at least approximately perpendicular to the axis 34 about which the ramp 32 pivots. This arrangement advantageously bridges the gaps 50 when the flaps are deployed in a typical loading dock. Various other mounting and use configurations may be implemented with respect to where, how, and to what the safety device is mounted. The drawings provide a non-limiting example in which an abutment 12 serves as a host structure, with each device 100 mounted on a respective abutment 12 aside the leveler 30 (FIG. 2). Other examples are within the scope of the drawings.

Particular embodiments and features have been described with reference to the drawings. It is to be understood that these descriptions are not limited to any single embodiment or any particular set of features, and that similar embodiments and features may arise or modifications and additions may be made without departing from the scope of these descriptions and the spirit of the appended claims.

What is claimed is:

1. A safety device for a loading dock, the safety device comprising:
a flap for covering a gap at a loading dock; and
a mounting plate pivotally attached to the flap, the mounting plate configured to pivotally mount the flap to a portion of the loading dock,
wherein the flap is pivotable relative to the mounting plate at least to an orthogonal position relative the mounting plate corresponding to a raised position relative to the loading dock and to a parallel position relative to the mounting plate corresponding to a deployed position relative to the loading dock and covering the gap.

2. The safety device of claim 1, wherein the flap comprises a rectangular polymer mat with reinforcing fiber.

3. The safety device of claim 1, wherein the flap comprises fiber layers sandwiched between at least external sealing polymer layers.

4. The safety device of claim 1, wherein the mounting plate is pivotally attached to the flap by way of a proximal edge of the mounting plate being pivotally attached to a proximal edge of the flap along a pivot axis.

5. The safety device of claim 4, further comprising a hinge plate, wherein the hinge plate is attached to the flap and is immovable relative to the flap, and wherein the hinge plate is pivotally attached to the mounting plate at the pivot axis.

6. The safety device of claim 5, wherein the hinge plate and mounting plate define a hinge.

7. The safety device of claim 6, wherein the hinge plate and mounting plate are pivotally attached at proximal edges thereof by mutually interdigitated rolls receiving and trapping a hinge pin disposed along the pivot axis.

8. The safety device of claim 4, wherein the flap has a greater area than an area of the mounting plate.

9. The safety device of claim 8, wherein the flap in the deployed position extends over and beyond the mounting plate in two dimensions.

10. The safety device of claim 8, wherein the flap and mounting plate are each rectangular.

11. The safety device of claim 10, wherein a length of the flap, as measured parallel to the pivot axis, is greater than a length of the mounting plate.

12. The safety device of claim 11, wherein the flap is pivotally attached to and longitudinally centered on the mounting plate, such that two longitudinal ends of the flap in the deployed position respectively overhang two longitudinal ends of the mounting plate.

13. The safety device of claim 12, wherein a width of the flap, as measured perpendicular to the length of the flap and perpendicular to the pivot axis, is greater than a width of the mounting plate.

14. The safety device of claim 13, wherein the flap and mounting plate are pivotally attached at the proximal edges thereof such that, such that the flap in the deployed position covers the mounting plate.
